(19) United States
(12) Patent Application Publication
(10) Pub. No.: US 2023/0060202 A1
(43) Pub. Date: Mar. 2, 2023

(54) ON-LINE EDUCATION PLATFORM

(71) Applicant: HeeYong JEONG, Seoul (KR)

(72) Inventor: HeeYong JEONG, Seoul (KR)

(21) Appl. No.: 17/643,693

(22) Filed: Dec. 10, 2021

(30) Foreign Application Priority Data
Aug. 24, 2021 (KR) 10-2021-0111319

(51) Int. Cl. G09B 5/12; G09B 5/14; G09B 5/06; G06F 21/32; G06Q 10/10; G06Q 50/20

(52) U.S. Cl. CPC G09B 5/12; G09B 5/14; G09B 5/06; G06F 21/32; G06Q 10/1091; G06Q 50/20

(57) ABSTRACT

An on-line education platform according to an embodiment of the present disclosure includes a main teacher video transmission system, an assistant teacher image management system, and a learning management system. The main teacher video transmission system unidirectionally provides a main teacher's teaching video to a plurality of student terminals. The assistant teacher image management system provides a bidirectional image or video together with each of the plurality of student terminals in response to event signals generated from the main teacher video transmission system and the plurality of student terminals based on the main teacher's teaching video. The learning management system provides control signals based on the event signals generated from the main teacher video transmission system and the plurality of student terminals and a remote support signal provided from the assistant teacher image management system.

### CROSS-REFERENCE TO RELATED APPLICATION(S)

This application is based on and claims priority under 35 U.S.C. § 119 to Korean Patent Application No. 10-2021-0111319, filed on Aug. 24, 2021, the disclosure of which is incorporated by reference herein in its entirety.

### FIELD OF THE INVENTION

The present invention is related to an on-line education platform.

### BACKGROUND OF THE INVENTION

Due to the corona virus that has recently occurred, educational institutions, including private educational institutes, have many difficulties in group education. In order to overcome the difficulties in group education, research is currently conducted on various on-line education methods.

### SUMMARY OF THE INVENTION

The present invention provides an on-line education platform capable of reducing a load (data traffic) on a system by conducting remote video education using an assistant teacher image management system providing a bidirectional image or video together with each of a plurality of student terminals in response to event signals generated from a main teacher video transmission system, which provides a unidirecitional video, and the plurality of student terminals.

According to an embodiment of the present disclosure, an on-line education platform includes a main teacher video transmission system, an assistant teacher image management system, and a learning management system. The main teacher video transmission system unidirectionally provides a main teacher's teaching video to a plurality of student terminals. The assistant teacher image management system provides a bidirectional image or video together with each of the plurality of student terminals in response to event signals generated from the main teacher video transmission system and the plurality of student terminals based on the main teacher's teaching video. The learning management system provides control signals based on the event signals generated from the main teacher video transmission system and the plurality of student terminals and a remote support signal provided from the assistant teacher image management system.

The on-line education platform may operate in a plurality of operation modes. In a first operation mode among the plurality of operation modes, the learning management system may connect the main teacher video transmission system to the student terminals to provide the main teacher's teaching video to each of the plurality of student terminals. In a second operation mode among the plurality of operation modes, in response to a first event signal provided from the main teacher video transmission system among the event signals and a second event signal provided from each of the student terminals among the event signals, the assistant teacher image management system and the student terminal may be connected to each other to transmit requests through the bidirectional image or video between the assistant teacher image management system and the student terminal.

The first event signal provided from the main teacher video transmission system may be converted into a first control signal among the control signals in the learning management system, and the first operation mode may be switched to the second operation mode.

The second event signal provided from each of the student terminals may be converted into a second control signal among the control signals in the learning management system, and the first operation mode may be switched to the second operation mode.

When a practice is required while a main teacher is teaching, the main teacher video transmission system may provide the first event signal to switch the operation mode of the on-line education platform from the first operation mode to the second operation mode.

When a student has a question while taking the main teacher's teaching, each of the plurality of student terminals may provide the second event signal to switch the operation mode of the on-line education platform from the first operation mode to the second operation mode.

The assistant teacher image management system may include a plurality of assistant teacher terminals corresponding to the plurality of student terminals, respectively.

In a third operation mode among the plurality of operation modes, a question may be provided to the student terminals in response to a competition event signal provided from the main teacher video transmission system, and answers from students using the student terminals may be provided to the on-line education platform through the student terminals.

The on-line education platform may further include an attendance management system. The attendance management system may determine whether the plurality of students is present or absent based on an attendance processing region sectioned into a predetermined region and a voice recognition device authenticating identity by voice.

While the on-line education platform is in operation, the attendance management system may manage the attendance of the plurality of students by classifying the students into concentrated, non-concentrated, and out-of-screen states based on a distance by which each of the plurality of students is away from the attendance processing region.

In addition to the technical aspects of the present disclosure discussed above, other features and advantages of the present disclosure will be set forth below or may be apparent to those skilled in the art to which the present disclosure pertains from the following description.

According to the present disclosure, the following effect may be obtained.

In the on-line education platform according to the present disclosure, it is possible to reduce a load (data traffic) on the entire platform by conducting remote video education using the assistant teacher image management system providing a bidirectional image or video together with each of the plurality of student terminals in response to the event signals generated from the main teacher video transmission system, which provides a unidirecitional video, and the plurality of student terminals.

Further, other features and advantages of the present disclosure may be understood through the embodiments of the present disclosure.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a diagram illustrating an on-line education platform according to embodiments of the present invention.

FIG. 2 is a diagram illustrating an example of a teaching video provided in the on-line education platform of FIG. 1.

FIG. 3 is a diagram for explaining operation modes applied to the on-line education platform of FIG. 1.

FIG. 4 is a diagram for explaining control signals corresponding to event signals used in the on-line education platform of FIG. 1.

FIG. 5 is a diagram for explaining a second operation mode among the operation modes of the on-line education platform of FIG. 1.

FIG. 6 is a diagram for explaining an example of the second operation mode of FIG. 5 among the operation modes.

FIG. 7 is a diagram for explaining an operation between student terminals and an assistant teacher image management system included in the on-line education platform of FIG. 1.

FIG. 8 is a diagram for explaining an attendance management system included in the on-line education platform of FIG. 1.

FIGS. 9 and 10 are diagrams for explaining an operation example of the attendance management system of FIG. 8.

### DETAILED DESCRIPTION OF THE INVENTION

In the specification, in adding reference numerals for elements throughout the drawings, it should be noted that like reference numerals are used to denote like elements, wherever possible, even though the elements are shown in different drawings.

The terms described in the specification should be understood as follows.

Singular forms should be understood to include plural forms unless the context clearly indicates otherwise, and the scope should not be limited by the terms.

It should further be understood that the terms “comprise”, “have”, “include”, and the like do not preclude the presence or addition of one or more other features, integers, steps, operations, elements, parts, or combinations thereof.

Hereinafter, preferred embodiments of the present disclosure designed to solve the aforementioned problem will be described in detail with reference to the accompanying drawings.

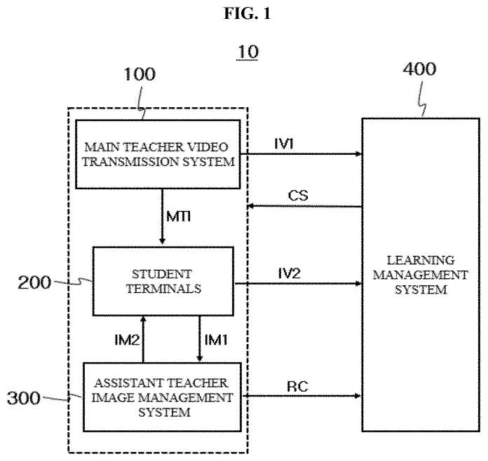

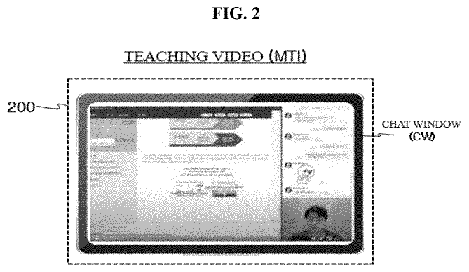

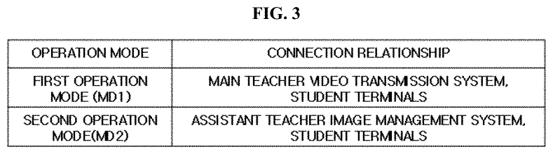

FIG. 1 is a diagram illustrating an on-line education platform according to embodiments of the present disclosure, FIG. 2 is a diagram illustrating an example of a teaching video provided in the on-line education platform of FIG. 1, and FIG. 3 is a diagram for explaining operation modes applied to the on-line education platform of FIG. 1.

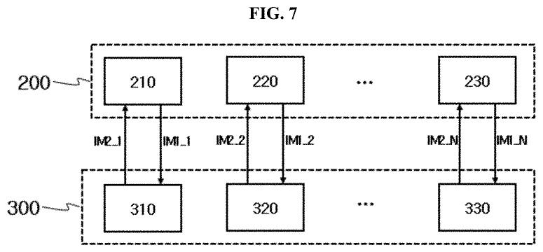

Referring to FIGS. 1 to 3, an on-line education platform 10 according to an embodiment of the present disclosure may include a main teacher video transmission system 100, an assistant teacher image management system 300, and a learning management system 400. The main teacher video transmission system 100 may unidirectionally provide a main teacher's teaching video MTI to a plurality of student terminals 200. The main teacher may be a teacher who teaches a plurality of students using the on-line education platform 10 according to the present disclosure. As disclosed in FIG. 7 to be described later, for example, the plurality of student terminals 200 may include a first student terminal 210, a second student terminal 220, . . . , and an N-th student terminal 230 (N is a natural number). When the main teacher provides a teaching video MTI through the main teacher video transmission system 100 in the on-line education platform 10 according to the present disclosure, the teaching video MTI may be transmitted unidirectionally from the main teacher video transmission system 100 to the first student terminal 210, the second student terminal 220, . . . and the N-th student terminal 230, and a plurality of students' videos may not be transmitted from the first student terminal 210, the second student terminal 220, . . . and the N-th student terminal 230 to the main teacher video transmission system 100.

When videos are transmitted bidirectionally between the main teacher video transmission system 100 and the plurality of student terminals 200, data traffic may increase and the teaching video MTI may be lagging. In order to solve this problem, in the on-line education platform 10 according to the present disclosure, the teaching video MTI is provided only through the main teacher video transmission system 100, and a bidirectional video is individual transmitted through the assistant teacher image management system 300 together with the student terminals 200, thereby making it possible to distribute the data traffic of the system included in the on-line education platform 10 and efficiently operate the on-line education platform 10. Meanwhile, although the main teacher video transmission system does not receive videos from students, the student terminals may display text, which causes little data traffic, in a chat window CW included in the teaching video MTI. For example, the main teacher video transmission system 100 may provide a teaching video through a YouTube channel.

In an embodiment, the on-line education platform 10 may operate in a plurality of operation modes MD. In a first operation mode MD1 among the plurality of operation modes MD, the learning management system 400 may connect the main teacher video transmission system 100 to the student terminals 200 to provide the main teacher's teaching video MTI to each of the plurality of student terminals 200.

The assistant teacher image management system 300 may provide a bidirectional image or video together with each of the plurality of student terminals 200 in response to event signals IV generated from the main teacher video transmission system 100 and the plurality of student terminals 200 based on the main teacher's teaching video MTI. For example, the assistant teacher image management system 300 is a system used by an assistant teacher to assist the main teacher, and may enable the assistant teacher and the students to provide bidirectional images or videos and audios through zooms. In a second operation mode MD2 among the plurality of operation modes MD, in response to a first event signal IV1 provided from the main teacher video transmission system 100 among the event signals IV and a second event signal IV2 provided from each of the student terminals 200 among the event signals IV, the assistant teacher image management system 300 and the student terminal may be connected to each other to transmit requests through the bidirectional image or video and audio between the assistant teacher image management system 300 and the student terminal.

The learning management system 400 may provide control signals CS based on the event signals IV generated from the main teacher video transmission system 100 and the plurality of student terminals 200 and a remote support signal RC provided from the assistant teacher image management system 300. For example, the event signal IV provided from the main teacher video transmission system 100 may be a first event signal IV1, and the event signal IV provided from the plurality of student terminals 200 may be a second event signal IV2. In this case, the first event signal IV1, the second event signals IV2, and the remote support signal RC provided from the image management system may be transmitted to the learning management system 400. In this case, the learning management system 400 may provide control signals CS corresponding to the first event signal IV1, the second event signals IV2, and the remote support signal RC. The control signals CS may include a first control signal CS1 and a second control signal CS2.

In the on-line education platform 10 according to the present disclosure, it is possible to reduce a load (data traffic) on the entire platform by conducting remote video education using the assistant teacher image management system 300 providing a bidirectional image or video together with each of the plurality of student terminals 200 to assist the main teacher's video teaching in response to the event signals IV generated from the main teacher video transmission system 100, which provides a unidirecitional video, and the plurality of student terminals 200.

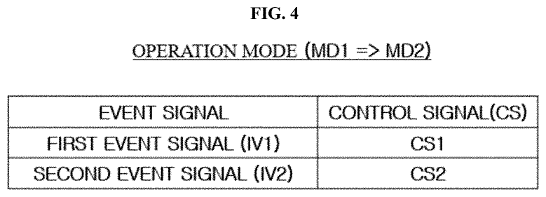

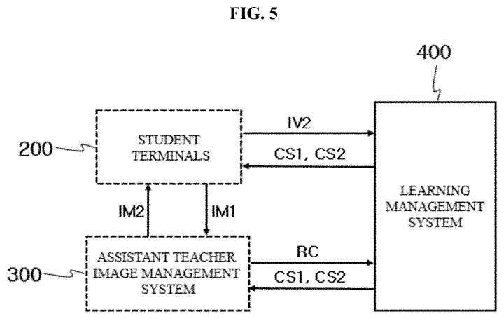

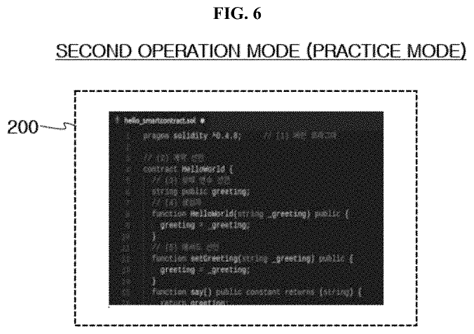

FIG. 4 is a diagram for explaining the control signals corresponding to the event signals used in the on-line education platform of FIG. 1, FIG. 5 is a diagram for explaining the second operation mode MD2 among the operation modes MD of the on-line education platform of FIG. 1, FIG. 6 is a diagram for explaining an example of the second operation mode MD2 of FIG. 5 among the operation modes MD, and FIG. 7 is a diagram for explaining an operation between the student terminals and the assistant teacher image management system included in the on-line education platform of FIG. 1.

Referring to FIGS. 1 to 7, the first event signal IV1 provided from the main teacher video transmission system 100 may be converted into the first control signal CS1 among the control signals CS in the learning management system 400, and the first operation mode MD1 may be switched to the second operation mode MD2. For example, when a practice is required while the main teacher is teaching, the main teacher video transmission system 100 may provide the first event signal IV1 to switch the operation mode of the on-line education platform 10 from the first operation mode MD1 to the second operation mode MD2.

In an embodiment, the second event signal IV2 provided from each of the student terminals 200 may be converted into the second control signal CS2 among the control signals CS in the learning management system 400, and the first operation mode MD1 may be switched to the second operation mode MD2. For example, when a student has a question while taking the main teacher's teaching, each of the plurality of student terminals 200 may provide the second event signal IV2 to switch the operation mode of the on-line education platform 10 from the first operation mode MD1 to the second operation mode MD2.

In an embodiment, the assistant teacher image management system 300 may include a plurality of assistant teacher terminals corresponding to the plurality of student terminals 200, respectively. For example, the plurality of student terminals 200 may include a first student terminal 210, a second student terminal 220, . . . and an N-th student terminal 230 (N is a natural number), and the plurality of assistant teacher terminals may include a first assistant teacher terminal 310, a second assistant teacher terminal 320, . . . and an N-th assistant teacher terminal 330 (N is a natural number).

When the on-line education platform 10 according to the present disclosure operates in a practice mode of the second operation mode MD2 among the plurality of operation modes MD, the first student terminal 210 may be connected to the first assistant teacher terminal 310. When the first student terminal 210 is connected to the first assistant teacher terminal 310, a video and audio IM1_1 of a first student using the first student terminal 210 may be transmitted to the first assistant teacher terminal 310, and a video and audio IM2_1 of a first assistant teacher using the first assistant teacher terminal 310 may be transmitted to the first student terminal 210. In the same manner, videos and audios may be transmitted bidirectionally between the plurality of student terminals 200 and the plurality of assistant teacher terminals. Although the plurality of student terminals 200 and the plurality of assistant teacher terminals are matched in a one-to-one manner here, multiple student terminals 200 may be connected to one assistant teacher terminal if necessary.

In an embodiment, in a third operation mode among the plurality of operation modes MD, a question may be provided to the student terminals 200 in response to a competition event signal provided from the main teacher video transmission system 100, and answers from students using the student terminals 200 may be provided to the on-line education platform 10 through the student terminals.

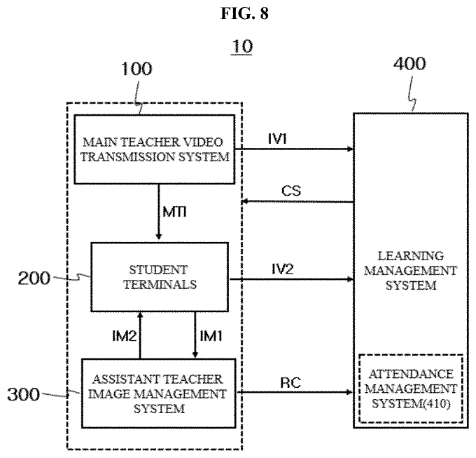

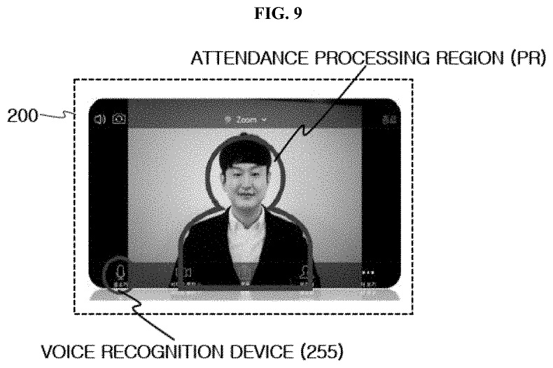

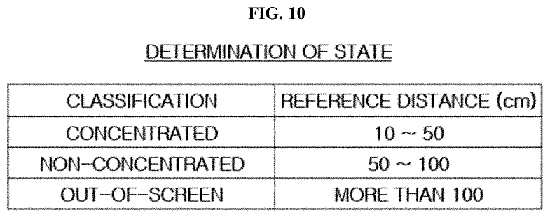

FIG. 8 is a diagram for explaining an attendance management system included in the on-line education platform of FIG. 1, and FIGS. 9 and 10 are diagrams for explaining an operation example of the attendance management system of FIG. 8.

Referring to FIGS. 1 to 10, the on-line education platform 10 may further include an attendance management system 410. The attendance management system 410 may determine whether a plurality of students are present or absent based on an attendance processing region PR sectioned into a predetermined region and a voice recognition device 255 authenticating identity by voice. For example, the attendance processing region PR and the voice recognition device 255 may be displayed on a display included in the student terminal. When a student wants to check attendance, the student may adjust his/her location to fit his/her body including his/her face in the attendance processing region PR. Thereafter, the student may click a button indicating the voice recognition device 255 displayed on the display and record his/her voice, and the attendance management system 410 may compare the student's voice with already-stored voice to determine that the student is the same person. As another way, a student may utter an already-stored word or sentence to confirm that the student is the same person.

In an embodiment, while the on-line education platform 10 is in operation, the attendance management system 410 may manage the attendance of the plurality of students by classifying the students into concentrated, non-concentrated, and out-of-screen states based on a distance by which each of the plurality of students is away from the attendance processing region PR. For example, when the distance by which the student is away from the attendance processing region PR during teaching is in a range of 10 to 50 cm, the attendance management system 410 may determine that the student is in a concentrated state, and when the distance by which the student is away from the attendance processing region PR is in a range of 50 to 100 cm, the attendance management system 410 may determine that the student is in a non-concentrated state and transmit a warning message to the corresponding student terminal. In addition, when the distance by which the student is away from the attendance processing region PR is in a range of more than 100 cm, the attendance management system 410 may determine that the student is in an out-of-screen state, and check an out-of-screen state time. When the time for which the student is in the out-of-screen state is greater than or equal to a reference time corresponding to a predetermined time, the attendance management system 410 may treat the student as absent.

In the on-line education platform 10 according to the present disclosure, it is possible to reduce a load (data traffic) on the entire platform by conducting remote video education using the assistant teacher image management system 300 providing a bidirectional image or video together with each of the plurality of student terminals 200 in response to the event signals IV generated from the main teacher video transmission system, which provides a unidirecitional video, and the plurality of student terminals 200.

What is claimed is:

1. An on-line education platform, comprising:
a main teacher video transmission system unidirectionally providing a main teacher's teaching video to a plurality of student terminals;
an assistant teacher image management system providing a bidirectional image or video together with each of the plurality of student terminals in response to event signals generated from the main teacher video transmission system and the plurality of student terminals based on the main teacher's teaching video; and
a learning management system providing control signals based on the event signals generated from the main teacher video transmission system and the plurality of student terminals and a remote support signal provided from the assistant teacher image management system.

2. The on-line education platform of claim 1, wherein the on-line education platform operates in a plurality of operation modes,
in a first operation mode among the plurality of operation modes, the learning management system connects the main teacher video transmission system to the student terminals to provide the main teacher's teaching video to each of the plurality of student terminals, and
in a second operation mode among the plurality of operation modes, in response to a first event signal provided from the main teacher video transmission system among the event signals and a second event signal provided from each of the student terminals among the event signals, the assistant teacher image management system and the student terminal are connected to each other to transmit requests through the bidirectional image or video between the assistant teacher image management system and the student terminal.

3. The on-line education platform of claim 2, wherein the first event signal provided from the main teacher video transmission system is converted into a first control signal among the control signals in the learning management system, and the first operation mode is switched to the second operation mode.

4. The on-line education platform of claim 3, wherein the second event signal provided from each of the student terminals is converted into a second control signal among the control signals in the learning management system, and the first operation mode is switched to the second operation mode.

5. The on-line education platform of claim 4, wherein when a practice is required while a main teacher is teaching, the main teacher video transmission system provides the first event signal to switch the operation mode of the on-line education platform from the first operation mode to the second operation mode.

6. The on-line education platform of claim 5, wherein when a student has a question while taking the main teacher's teaching, each of the plurality of student terminals provides the second event signal to switch the operation mode of the on-line education platform from the first operation mode to the second operation mode.

7. The on-line education platform of claim 6, wherein the assistant teacher image management system includes a plurality of assistant teacher terminals corresponding to the plurality of student terminals, respectively.

8. The on-line education platform of claim 7, wherein in a third operation mode among the plurality of operation modes, a question is provided to the student terminals in response to a competition event signal provided from the main teacher video transmission system, and answers from students using the student terminals are provided to the on-line education platform through the student terminals.

9. The on-line education platform of claim 8, further comprising an attendance management system determining whether the plurality of students are present or absent based on an attendance processing region sectioned into a predetermined region and a voice recognition device authenticating identity by voice.

10. The on-line education platform of claim 9, wherein while the on-line education platform is in operation, the attendance management system manages the attendance of the plurality of students by classifying the students into concentrated, non-concentrated, and out-of-screen states based on a distance by which each of the plurality of students is away from the attendance processing region.
